(19) United States
(12) Patent Application Publication
(10) Pub. No.: US 2020/0111186 A1
(43) Pub. Date: Apr. 9, 2020

(54) SYSTEM AND METHOD FOR MANAGING AND TRACKING IP, PARTICULARLY ABANDONED IP, ON A BLOCKCHAIN

(71) Applicant: Knowbella Tech, LLC, Cincinnati, OH (US)

(72) Inventor: Jason E. BARKELOO, Cincinnati, OH (US)

(73) Assignee: Knowbella Tech, LLC, Cincinnati, OH (US)

(21) Appl. No.: 16/591,786

(22) Filed: Oct. 3, 2019

Related U.S. Application Data
(60) Provisional application No. 62/740,663, filed on Oct. 3, 2018.
(60) Provisional application No. 62/756,146, filed on Nov. 6, 2018.
(60) Provisional application No. 62/796,683, filed on Jan. 25, 2019.

(51) Int. Cl. G06Q 50/18; G06F 9/54; G06F 16/23

(52) U.S. Cl. CPC G06Q 50/184; G06F 16/2379; G06F 9/547

(57) ABSTRACT

The present disclosure pertains to a system configured to manage and track intellectual property (IP). Some embodiments of this system may include: an application programming interface (API) having access to a web-accessible IP database; an artificial intelligence (AI) or learning engine coupled to the API and operating the API to query the web-accessible IP database for orphaned IP assets that have become abandoned, expired, and/or public domain assets; and a user-collaboration platform. Some embodiments of this platform may: receive information from the API concerning the orphaned IP assets found by the API; store the information concerning each of the orphaned IP assets on a blockchain data structure; provide access to the orphaned IP assets stored on the blockchain data structure to users via a network; and record user activity concerning user access, development, sharing, and/or modification of the orphaned IP assets on the blockchain data structure.

### CROSS-REFERENCE TO RELATED APPLICATIONS

This application claims the benefit of the priority date of U.S. Provisional Application No. 62/740,663 filed on Oct. 3, 2018 and entitled “System And Method For Managing And Tracking IP, Particularly Abandoned IP, On A Blockchain,” U.S. Provisional Application No. 62/756,146 filed on Nov. 6, 2018 and entitled “System And Method For Managing And Tracking IP, Particularly Abandoned IP, On A Blockchain,” and U.S. Provisional Application No. 62/796,683 filed on Jan. 25, 2019 and entitled “System And Method For Managing And Tracking IP, Particularly Abandoned IP, On A Blockchain,” the entire contents of each of which are incorporated herein by reference.

### BACKGROUND

Scientists are among the most highly educated population on Earth. They increase the knowledge that changes the way we understand our world and the universe. Scientists are influencers and decision-makers at every level.

Scientists work in a system dominated by a “publish or perish” model. Researchers are dependent on grant funding to support their experimental work. The process of applying for a grant and writing a manuscript is a time intensive investment. After the research is conducted, scientists hope their manuscript will be accepted for publication. However, frequently the scientists are exploited during the publication process.

Compounding this problem is the protectionist “silo” model in which research teams working in isolation frequently cannot share knowledge across other disciplines or across the boundaries of their institutions due to employment agreements. Worse still, if an institution does not monetize a researcher's work through patenting and licensing, the IP may never realize value beyond a publication. As a result, this creates idle intellectual property (IP). As such, other researchers miss out on the opportunity to build upon the now-dormant IP. This can waste time and money because the uninformed researchers may duplicate the same or similar research that is dormant.

By some accounts there is a global shortage of STEM scientists to meet formal employment needs. By another account, the “skill set mismatch might give the appearance of a STEM worker shortage”. Another data point may indicate the “push by high-tech companies [in the U.S.] for more H1-B visas is also an indication that they are not finding the needed skills within the United States; therefore, companies looking to foreign countries for STEM workers with matching skills is an indication of a skills mismatch.” Regardless, technology companies are in a fierce battle for the top talent. Technology companies can no longer afford to recruit talent in an on-demand or a just-in-time process. Just as professional sports teams start scouting athletes years in advance, technology companies must start scouting and recruiting their employees months and years in advance.

Furthermore, researchers often find a mismatch in their current position or would like to change their career path or area of research. Thus, they need a platform where they can take control and gain access and experience in areas they wish to work and advance their careers.

When scientists openly collaborate they are building dynamic web-based personage that provides employers a real-time window into the expertise of each researcher that opts-in to be recognized. Today, there is no scientific talent pool that freely provides researchers all the tools they need to participate in the new open science movement.

Legacy services such as LinkedIn® cannot provide any assurance the potential candidate's information is accurate and not fabricated. Additionally, these profiles are generally stale and not updated regularly. Both of these conditions require the recruiter to spend more time vetting candidates they find through searching legacy recruiting services. The Current Platform solves these problems.

The global annual research and development (R&D) spending is approximately $2 trillion. Of that, billions of dollars are wasted each year to solve problems that have already been solved but are not widely known. Much of the research is conducted in corporate and institutional silos and lots of information sits behind publisher paywalls. These silos and paywalls deny data access to underserved researchers, particularly in Africa, Asia, and Latin America.

Scientists labor for months, even years, to produce findings that increase knowledge and benefit society. These findings undergo a lengthy and sometimes controversial peer review process in order to get published. A published manuscript is available in expensive subscription journals or open access journals funded by steep Article Processing Charges (APC) usually paid by the authors. Scientists are dependent on publications to secure their next round of funding, advance their authorship status, and achieve career tenure. It is a cumbersome process with many pain points, and these scientists are the fortunate ones. Some see their findings stuck in lengthy peer review or unpublishable due to negative results or lack of originality. Others simply do not have the resources to participate in this system at all. In the meantime, a potential goldmine of unshared IP and knowledge collects dust, out of reach of scientists who could grow its value.

Intellectual property (IP) sits idle on the shelves of many corporations, universities, inventor workspaces and other locations. In the IP world, it is known as dormant and orphan IP. The research, data, and insights within this IP are never published or shared, due to budgetary constraints, lack of market insights, lack of awareness of the IP, or lack of perceived marketability and value. Technology Transfer Officers must make tough decisions on which IP has marketability. However, those decisions are often based on the limits of the jurisdiction in which the IP was filed or budgetary constraints. When that idle IP is opened up to the global scientific community, new opportunities never previously envisioned may be realized.

Science is a social endeavor, but in today's competitive environments, much of modern science is conducted in “patent silos”—scientists working in isolation, their research locked down within the boundaries of institutions. This hinders knowledge growth, discovery, and innovation.

Many scientists are frustrated with the costs, timeline, and procedures required to get their research reviewed and published. Publisher peer review and workflow processes can take up to a year or more and require a serious investment of additional researcher time. The researcher's work sits idle instead of being advanced into the global scientific community.

Grant funders depend on published research as verification of their financial support, so they have to navigate the same cumbersome, time-consuming system. Sponsors looking to drive innovation have to deal with too many third parties and “middle men” to support the research they believe in.

A great divide exists between the professional scientific community and the public. Increasing awareness and enthusiasm toward scientific innovation is critical to improving our society and environment. There is an opportunity to bridge any gap between science and the public to grow support and continue funding scientific research. By bridging this gap we can create more awareness to develop STEM talent, especially for women and minorities.

Globally, there are many scientists that want to collaborate with fellow researchers, but have limited or no access to IP and collaborative tools. They also want access to Key Opinion Leaders who influence careers and facilitate pathways to publishing and funding. Underserved scientists have great potential to make significant contributions to science and advance their careers but many cannot even afford access to scientific journals or basic lab equipment.

A large number of excellent tools and services exist to support and enhance scientific collaboration, innovation, and development, but they are fragmented across multiple vendors and systems. This creates great inefficiencies that slow the pace and quality of innovation. There is no end-to-end ecosystem that serves IP producers and consumers rather than the needs of the tool and service providers.

Science happens in a transactional space. Grant funding is a transaction of money. Publishing is a transaction of information. Peer review is a transaction of time and expertise. There are many players (scientists, funders, institutions, publishers, etc.) and many assets (IP, money, equipment, knowledge, etc.). The complex exchange of these diverse assets among the many players raises concerns of trust and security. Any solution must address these concerns.

### SUMMARY

The present disclosure relates to a system for managing and tracking intellectual property (IP). This system may include: an application programming interface (API) having access to one or more web-accessible electronic IP databases; one or more of an artificial intelligence (AI) engine or learning engine coupled to the API and operating the API to query the one or more web-accessible IP databases for orphaned IP assets that have become abandoned, expired and/or public domain assets; and an electronic user-collaboration platform. This platform may: receive information from the API concerning the orphaned IP assets found by the API; store the information concerning each of the orphaned IP assets on a blockchain data structure; provide access to the orphaned IP assets stored on the blockchain data structure to a plurality of users via an electronic network; and record user activity concerning user access, development, sharing and/or modification of the orphaned IP assets on the blockchain data structure.

The present disclosure further relates to a method for managing and tracking IP. This method may include: collecting information concerning orphaned IP assets that have become abandoned, expired and/or public domain; storing the orphaned IP information on a blockchain data structure; providing access to the orphaned IP information stored on the blockchain data structure to users over a computer network via an electronic collaboration platform; and memorializing on the blockchain user activity with respect to the orphaned IP information.

The present disclosure further relates to a system for managing and tracking IP. This system may include: an API having access to one or more web-accessible electronic IP databases; one or more of an AI engine or learning engine coupled to the API and operating the API to query the one or more web-accessible IP databases for IP assets; and an electronic user-collaboration platform. This platform may: receive information from the API concerning the IP assets found by the API; store the information concerning each of the IP assets on a blockchain data structure; provide access to the IP assets stored on the blockchain data structure to a plurality of users via an electronic network; and record user activity concerning user access, development, sharing and/or modification of the IP assets on the blockchain data structure.

The present disclosure further relates to a system for collaborative development of IP. This system may include: a blockchain data structure storing information concerning IP assets; and an electronic user-collaboration platform having access to the blockchain data structure. This platform may: provide access to the IP assets stored on the blockchain data structure to a plurality of researchers via an electronic network; and record user activity concerning user access, development, sharing and/or modification of the IP assets on the blockchain data structure.

The present disclosure further relates to a system for collaborative development of IP. This system may include: a blockchain data structure storing information concerning IP assets; and an electronic user-collaboration platform having access to the blockchain data structure. This platform may: provide access to the IP assets stored on the blockchain data structure to a plurality of researchers via an electronic network, where the blockchain data structure further includes profile information of researchers accessing the IP assets on the blockchain data structure; and collect at least one credential information from the researchers as a condition to providing the researchers access to the blockchain data structure.

The method is implemented by a system comprising one or more hardware processors configured by machine-readable instructions and/or other components. The system comprises the one or more processors and other components or media, e.g., upon which machine-readable instructions may be executed. Implementations of any of the described techniques and architectures may include a method or process, an apparatus, a device, a machine, a system, or instructions stored on computer-readable storage device(s).

### BRIEF DESCRIPTION OF THE DRAWINGS

The details of particular implementations are set forth in the accompanying drawings and description below. Like reference numerals may refer to like elements throughout the specification. Other features will be apparent from the following description, including the drawings and claims. The drawings, though, are for the purposes of illustration and description only and are not intended as a definition of the limits of the disclosure.

FIG. 1 illustrates an example of a system for managing and tracking intellectual property (IP) by searching databases and storing search results into a blockchain to facilitate collaboration among platform users, in accordance with one or more embodiments.

FIG. 2 illustrates a system for collaborative development of IP via a blockchain-enabled open science collaboration platform, in accordance with one or more embodiments.

### DETAILED DESCRIPTION

As used throughout this application, the word “may” is used in a permissive sense (i.e., meaning having the potential to), rather than the mandatory sense (i.e., meaning must). The words “include,” “including,” and “includes” and the like mean including, but not limited to. As used herein, the singular form of “a,” “an,” and “the” include plural references unless the context clearly dictates otherwise. As employed herein, the term “number” shall mean one or an integer greater than one (i.e., a plurality).

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other.

The current Platform crowdsources the global scientific and engineering communities around idle IP, so researchers can collaborate on research projects, gain grants, share laboratory resources, get early feedback through preprint service, develop manuscripts for publication, and earn crypto-currency tokens. Embodiments of the current disclosure will help scientists around the world find previously hidden knowledge, connect with others to grow that knowledge, disseminate their findings more quickly than through the traditional publishing model, and reward them for their contributions to the scientific community.

The current Platform provides a matching service for IP producers looking to derive value from their idle IP, and IP consumers (scientists) who do new research based on that IP. The Platform provides employment matching opportunities for researchers and hiring organizations. This makes the current Platform a unique vertical and horizontal platform.

By open sourcing IP into a crowdsource platform, embodiments of the current disclosure enable knowledge and value to grow in untold new and different directions, meeting an unmet need outside of the borders that currently exist in research and development. We want to open up and decentralize science, in order to maximize social good, generate economic incentives, and improve our world.

Embodiments of the current disclosure allow these entities to unlock this idle IP and open it up to all researchers on the Platform. Just as GitHub® is a developer community for open source software projects, the Current Platform is a researcher community for open source IP projects. The Platform provides researchers with IP, access to grant funding and lab equipment, manuscript development tools, preprint server, career and gig opportunities, and Helix token rewards for collaborating.

Scientists can choose to work on IP and be recruited by employers, all the while they will have the opportunity to connect, collaborate and work with other researchers and key thought leaders around the world. They will develop relationships as well as build their credibility and professional reputations. This Platform especially enables young and underserved scientists around the world to take control and advance their careers. They now have a platform to become rising stars and drive their careers and opportunities in directions they never before imagined.

Due to the Platform's unique use of blockchain, funders and scientists establish mutual trust and transparency to share in the success of innovation goals. This allows the community utilizing the current Platforms to be democratized and self-governing.

It leverages blockchain technology for enabling scientists to vote on grant funding through indelible and transparent voting. Because scientists are working in real-time on the Platform, those that opt-in can be recruited by organizations seeking their research skills. Companies and researchers can then begin building relationships for future project and employment opportunities.

A professional who opts-in will have his/her profile updated dynamically. The profile is also tied to the areas within the platform where the scientist is collaborating (similar to GitHub®). This gives the recruiter real-time and accurate insights into the candidate's skills, publications, teamwork abilities, and leadership abilities.

In an embodiment, the electronic user-collaboration platform collects credential information from the researchers as a condition to providing the researchers access to the platform and the blockchain data structure. In this embodiment, when a user attempts to register on the Knowbella Platform, s/he must authenticate a science background or focus. During the registration process, if the user selects s/he is a practicing researcher, s/he will be asked to upload any, some, or all; a diploma, academic transcripts, job description and proof of employment in STEM position, peer reviewed journal article, professional license, letter of reference from employer, or “other” that demonstrates s/he is a practicing scientist. For students focused on STEM (STEMs), s/he will upload transcripts, diploma, student ID, letter of reference from professor, job description, letter of reference from employer, or “other” that demonstrates s/he is working toward a STEM degree. For citizen scientists, a letter of reference, copy of mailing label of a journal subscription, a written request outlining area(s) of focus and reason for requesting to join, peer reviewed journal article, draft journal article, or “other” that demonstrates the applicant has a STEMs focus.

Once the credential(s) are uploaded or postal mailed to the Company, an individual and/or optical character recognition application with an artificial intelligence (AI) may determine the authenticity of the credential and approve/disapprove the submission. Once the credential is approved/disapproved, its status is transferred to a blockchain, such as in or with the profile information associated with the user. In the case of the AI system, the blockchain is integrated with the AI and an automatic update of the blockchain occurs. Because of the blockchain storage, the approved credential can follow the individual to other sites as a single sign-on credential or proof of status in other website log-ins. The system may also automatically update the credential information on the blockchain in response to how the user interacts with the platform, with the blockchain and/or with other researchers on the platform.

Such a credential verification and maintenance system may provide an alternative to platforms such as ORCID. The current platform may give persona credential control to the researcher so s/he can determine what data to give up, monetize that data when possible (e.g., sell to Facebook, for example, that s/he has a PhD in biology), and have that credential token follow him/her to other scientific and non-scientific entities.

Embodiments of the current disclosure's talent recruiting effort provides companies who subscribe for dashboard access to source, pipeline, and nurture candidates who opt-in. Embodiments of the current disclosure user profiles are built around actual activities by the researchers and are up-to-date as the scientists collaborate. Tools such as LinkedIn® are not as reliable as user profiles are often stale and users can fabricate their profiles. Embodiments of the current disclosure captures factual data and provides multidimensional user profiles only for those researchers who opt-in. This Embodiments of the current disclosure recruiting system decreases the hiring cycle time, builds a talent pipeline and provides a better vetting of employment candidates. This model also opens employment opportunities to researchers in under-represented areas of the world where current employment recruiting does not reach.

In summary, researchers who opt-in can be “scouted” for employment opportunities without taking valuable time to build online profiles that recruiters tend to not trust until after spending valuable time and money to verify.

The researchers' profile and/or credentials stored and maintained on the blockchain may be used to assist with such job recruitment. The researcher's profile and/or credentials may serve as a basis for a persona that as the researcher develops new work the profile and/or credentials are automatically updated on the blockchain.

Embodiments of the current disclosure opens up abandoned/expired/public-domain IP for the benefit of all. Idle IP brings little value to the institution or inventors. In some cases, it might actually be costing money. By out-licensing idle IP to an open platform, scientific institutions can unlock the value of their IP by exposing it to a global community of science-minded users. This can enhance the institution's brand and recruitment activities. It may also enhance the institution's licensing activities by providing free exposure to the global community with the provided open IP.

Open IP provides an interdisciplinary opportunity to the IP that may produce new applications and discoveries that otherwise may never develop. Opening up this locked-down knowledge to the wisdom of the crowd could result in significant discoveries and innovations. It also makes the researcher whose IP is dormant a bit happier by increasing the number of potential co-authors to new advancements. The researcher can also gain exposure as a thought leader, which in turn could lead to sponsored research and consulting opportunities.

Embodiments of the current disclosure makes open IP available to a community of professional researchers, citizen scientists, teachers, students, and enthusiasts—anyone looking to contribute to the advancement of discoveries and innovations. By collaborating across borders and institutions, the current platform can accomplish great things and improve our world. In line with our commitment to open science, all research based upon IP within the current platform must be made available under a Creative Commons 4.0 and Copyleft model. This Open Data and Open Access model is novel for the modern science culture, but it returns science to the open and collaborative model that fostered world changing discoveries such as the cure for smallpox.

Scientists can start with existing IP and develop it (or “fork” it) into new directions and applications. The IP remains open under a CC licensing model and may be developed further. That IP requires all developments to be freely provided to all researchers on the Platform. This model expands the potential and value of the original IP with a network effect.

The current platform supports the “Open Access” publishing model, putting much of the control of publishing science back into the researcher's hands. Since all research is open, authors may seek “pre-peer review” at any point in the manuscript development process so potential problems can be addressed before a significant investment of time is made. Finished manuscripts are uploaded to a Preprint server for further review and for Open Access publishers to compete to publish them.

Whether from large grant-issuing institutions or crowdsourcing philanthropic donations, the current platform connects available funds with researchers and establishes mutual trust, transparency and accountability via blockchain technology. As a result, the Current platform promotes the success of shared research goals.

The current platform enables everyday enthusiasts and citizen scientists to learn, collaborate, observe, donate funds, and even vote on projects that should receive funding. With market acceptance of the current platform, donations, grants, and sponsored research will grow, continuing to bridge the gap and empowering both scientists and science-minded citizens.

Embodiments of the current disclosure's Open Research model enables scientists can gain access to knowledge, networking, and resources that have previously been out of reach. Scientists can collaborate across the globe, do research around open IP, acquire equipment through a free Asset Exchange, and review the findings of research projects as they are underway. Fulfillment of this unrealized potential benefits both individual scientists and the cause of science.

The end-to-end ecosystem provided by embodiments of the current disclosure gathers inventors, institutions, researchers, foundations, educators, students and citizens together, and gives them the tools to work together to advance science. Free access to the platform includes open IP, network and community building features, communication and collaboration tools, a grant management system, manuscript development process, preprint server, free equipment exchange, and advanced search and matching tools to find and connect with the people, projects, content, and resources most relevant to each user's interests and goals.

Blockchain technology has been widely recognized as the driver of the next seismic shift, comparable to the impact of the Internet in the 1980s. Integrating blockchain technology into the current platform not only enables solutions to long-standing barriers to scientific innovation. The blockchain-powered current platform enables the most suitable solutions, assets and human capital from around the globe to become available to regional or even specific local communities in the most cost-effective manner, unencumbered by foreign IP laws and incompatible business practices.

Moving from the centralized storage of scientific data to a blockchain protects it against system failure, fraud, censorship and other security risks. With a blockchain, the research and its provenance can be stored via a storage protocol such as Ethereum's Swarm or the “InterPlanetary File System” (IPFS). These decentralized and distributed systems can store and relay large volumes of information, without the potential downfalls of large, centralized servers.

With the Ethereum blockchain's smart contracts and immutable ledger powering transactions of funds, research, resources, staffing, and more, embodiments of the current disclosure can minimize friction and costs typically associated with the conduct of science in research institutions. Blockchain technology streamlines a comprehensive ecosystem around open technologies, empowering the current platform and community with a framework for unimaginable innovations based on blockchain transactions.

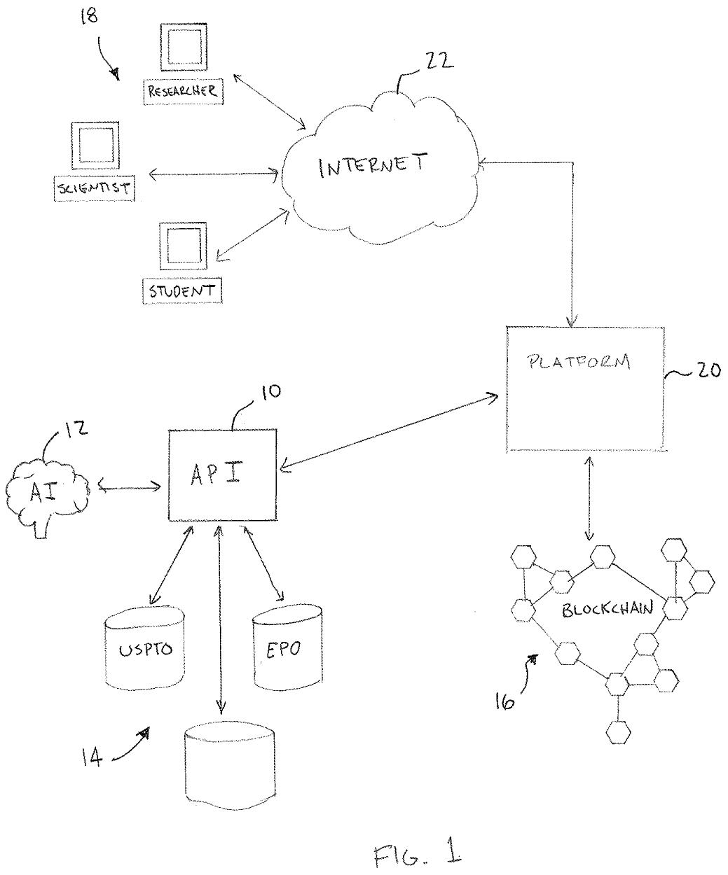

Exemplary Process: Referring to FIG. 1 an API 10, controlled by an artificial intelligence engine 12, searches IP stored in electronic databases 14 and stores the abandoned/expired/public-domain IP found in the search on a blockchain 16 so users 18 of the platform 20 can access the IP for collaboration on the platform, via the Internet 22 for example. The search would show what IP is 1) abandoned/expired/public-domain, 2) might soon be abandoned/expired/public-domain, and 3) is active (not currently or soon to be abandoned/expired/public-domain). All abandoned IP would be automatically on-boarded to the platform 20/16 and as users 18 access the IP stored on the blockchain, the advancements and progress in the IP through further research and collaboration would also be stored to the blockchain 16 to show it's open and it's provenance is open.

This process/system will rely on a AI/machine learning engine 12 to search patents databases 14 and make a decision whether 1) patent or application is abandoned/expired/public-domain, 2) might soon be abandoned/expired/public-domain (not being maintained), or 3) is being maintained. As each patent/application goes off provisional/patent our AI/machine learning engine 12 provided by frameworks such as PyTorch, TensorFlow, Keras, and libraries such as scikit-learn, gensim, spaCy, textaCy, etc., which is continually querying the patent DBs 14 around the world, would update the blockchain 16 and automatically on-board the IP to the platform 20. As the IP is on-boarded, the blockchain DB 16 is updated to show this. This utilizes an API 10 between the AI on the platform and patent DBs 14 so that auto updates to the blockchain 16 and platform occur 20. As the abandoned/expired/public-domain IP is worked on, or collaborated on, or developed or critiqued in the platform 20 by the users 18, the blockchain 16 is written and updated showing immutable provenance to ensure all progress remains open.

It will be appreciated that abandoned/expired/public-domain could be applied to manuscripts developed on the platform 20 as IP/patents are publications.

Researchers 18 are freely provided the IP stored on the blockchain 16 via the platform 20 under a Creative Commons 4.0 and Copyleft model. The researchers, in order to collaborate on the platform 20 and access the IP, grants, lab equipment, manuscript development tool, preprint server, and Helix token rewards for collaborating, must agree to a Terms of Service (TOS) that incorporates the CC 4.0/Copyleft model. Essentially, in order to freely use the Platform 20, users 18 agree that any progress they make will be freely provided back to the community.

The current platform 20 is a scientific crowdsourcing platform that “open sources” abandoned, dormant, and orphan (“dorphan”) IP.

IP may mean more than patents and patent applications. It is the entire body of content and knowledge that an inventor may have such as presentations, webinars, blog entries, unpublished manuscripts, trade secrets, etc. Therefore, with the license of abandoned and orphaned patents, the current model may also seek to get the IP and inventor engaged in the open source collaboration.

One might think of patent publications similar to journal articles. Therefore, just as abandoned patents might be scraped by AI 12, open access journal articles could also be scraped and matched up to the IP on the Platform 20. In this way, the community 18 working on a piece of IP could have their library updated continuously with new open access material as it becomes available.

Orphan IP may also encompass copyrighted works, which may be accessed via on-line databases. Orphan IP may also encompass CC licensed content and open source materials.

Embodiments of the current disclosure may also be used to track non-orphan IP (such as active and/or pending patents) in a similar manner via the block-chain. In such an embodiment, the AI engine 12 would be configured to search and locate a specific subset of non-orphan IP for storage and access on the blockchain 16 via the platform 20. The remaining components and steps may be similar as disclosed with other embodiments.

Why blockchain? Consider Wikipedia. When one makes an update to a page, the update is memorialized as provenance. However, it is done on a central server, subject to attacks and modifications. Blockchain solves this problem due to the secure distributed nature of the provenance database. In the case of IP, these secure immutable updates forever securely memorialize contributions. As such, and in accordance with Platform TOS, the memorialized contributions show a provenance of contributions that prevents users from circumventing the Platform and trying to use the prior art as a basis for patenting or developing other locked-down IP.

If this can be done with abandoned/expired/public-domain patents, it can be done with all patents, open access journal articles, and even content pages such as Wikipedia. It would also be possible to distribute other content across a blockchain and provide provenance for its creation to enforce Creative Commons licensing via smart contracts.

Another advantage of distributing the IP across a blockchain is reducing the susceptibility of a central server to attack that could modify databases and even take the server off-line. This also reduces costs of maintaining servers to host and serve the databases.

The goal of distributing the provenance of patent/IP developments is to securely provide credit to the developer under the CC4.0/copyleft model for developing the open IP hosted on the Platform. Knowing who created what IP is important because as users develop and contribute IP they are rewarded in cryptocurrency tokens (Ethereum ERC20-based cryptocurrency tokens), which is tradable on international exchanges and can even be tied to company equity as a security.

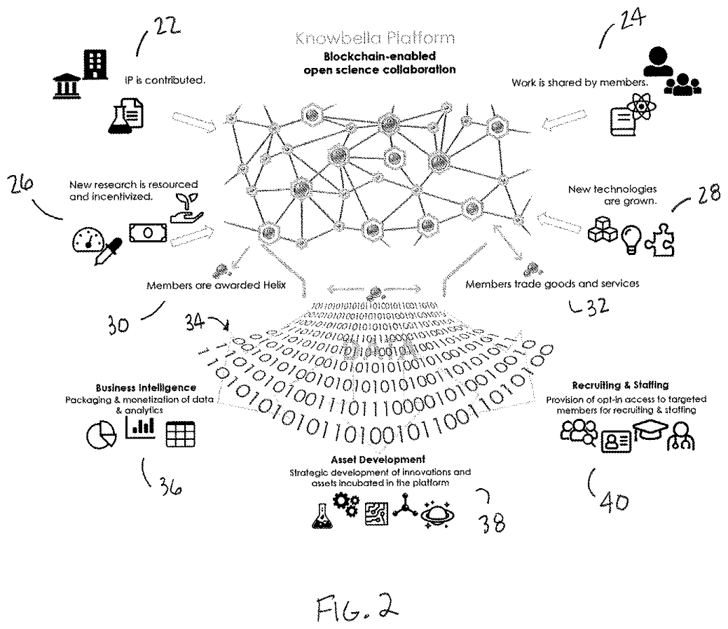

FIG. 2 illustrates additional advantages and technical improvements provided by the block-chain enables open science collaboration platform 20 as described herein. In addition to the abandoned/expired/public-domain IP found by the AI 12, scientific institutions and companies may contribute dormant and orphaned IP 22. Scientists and research groups share their work, to be matched with relevant IP, content and fellow members 24. Institutions, individuals and the crowd provide equipment and/or resources and incentivize new research 26. Scientists collaborate on research based on contributed IP and grow new technologies 28. Members may be awarded cryptocurrency for contributing IP, developing IP, growing the community, etc. 30. Members may trade goods and services with each other using cryptocurrency or traditional flat currency 32. Data is collected and stored with respect to such activities 34. Business intelligence may be mined from such data 36. Strategic development of innovations and assets incubated in the platform 20 based on mining such data 38. The data may also be mined to access to members 18 for recruiting and staffing purposes 40.

Several embodiments of the invention are specifically illustrated and/or described herein. However, it will be appreciated that modifications and variations are contemplated and within the purview of the appended claims.

What is claimed is:

1. A system for managing and tracking intellectual property comprising:
an application programming interface having access to one or more web-accessible electronic intellectual property databases;
one or more of an artificial intelligence engine or learning engine coupled to the application programming interface and operating the application programming interface to query the one or more web-accessible intellectual property databases for orphaned intellectual property assets that have become abandoned, expired and/or public domain assets; and
an electronic user-collaboration platform,
receiving information from the application programming interface concerning the orphaned intellectual property assets found by the application programming interface,
storing the information concerning each of the orphaned intellectual property assets on a blockchain data structure,
providing access to the orphaned intellectual property assets stored on the blockchain data structure to a plurality of users via an electronic network, and
recording user activity concerning user access, development, sharing and/or modification of the orphaned intellectual property assets on the blockchain data structure.

2. The system of claim 1, wherein the one or more artificial intelligence engine or learning engine operates the application programming interface to query the one or more web-accessible intellectual property databases on a periodic basis.

3. The system of claim 1, wherein the electronic user-collaboration platform stores data regarding users and user activity, wherein such data is used for one or more of: (a) calculating crypto-currency awards to users, (b) career recruiting activities by third parties, and/or (c) connecting users with access to grant funding, lab equipment, manuscript development tools, and/or preprint server manuscript review.

4. The system of claim 1, wherein the platform maintains profiles of users that are updated dynamically by the platform based upon the user's activity with respect to the platform.

5. A method for managing and tracking intellectual property, comprising the steps of:
collecting information concerning orphaned intellectual property assets that have become abandoned, expired and/or public domain;
storing the orphaned intellectual property information on a blockchain data structure;
providing access to the orphaned intellectual property information stored on the blockchain data structure to users over a computer network via an electronic collaboration platform; and
memorializing on the blockchain user activity with respect to the orphaned intellectual property information.

6. The method of claim 5, further comprising:
collecting data concerning user activity with respect to the orphaned intellectual property information stored on the blockchain; and
one or more of: (a) calculating crypto-currency awards to users, (b) facilitating career recruiting activities by third parties, and/or (c) connecting users with access to grant funding, lab equipment, manuscript development tools, and/or preprint server manuscript review.

7. The method of claim 5, wherein the collecting step is controlled, at least in part, by an artificial intelligence and/or learning engine.

8. The method of claim 7, wherein the collecting is performed by an application program interface having access to one or more electronic intellectual property databases, under the control of the artificial intelligence and/or learning engine.

9. The method of claim 6, further comprising maintaining profiles of users that are updated dynamically based upon the user's activity with respect to the orphaned intellectual property stored on the blockchain data structure.

10. A system for managing and tracking intellectual property comprising:
an application programming interface having access to one or more web-accessible electronic intellectual property databases;
one or more of an artificial intelligence engine or learning engine coupled to the application programming interface and operating the application programming interface to query the one or more web-accessible intellectual property databases for intellectual property assets; and
an electronic user-collaboration platform,
receiving information from the application programming interface concerning the intellectual property assets found by the application programming interface,
storing the information concerning each of the intellectual property assets on a blockchain data structure,
providing access to the intellectual property assets stored on the blockchain data structure to a plurality of users via an electronic network, and
recording user activity concerning user access, development, sharing and/or modification of the intellectual property assets on the blockchain data structure.

11. A system for collaborative development of intellectual property comprising:
a blockchain data structure storing information concerning intellectual property assets; and
an electronic user-collaboration platform having access to the blockchain data structure,
providing access to the intellectual property assets stored on the blockchain data structure to a plurality of researchers via an electronic network, and
recording user activity concerning user access, development, sharing and/or modification of the intellectual property assets on the blockchain data structure.

12. The system of claim 11, wherein the blockchain data structure includes profile information of researchers accessing the intellectual property assets on the blockchain data structure, and the electronic user-collaboration platform automatically updates the profile information based upon the researchers' activities with respect to the intellectual property assets stored on the blockchain data structure.

13. The system of claim 12, wherein the user-collaboration platform allows researchers to opt-in or opt-out of the automatic updating of the profile information.

14. The system of claim 12, wherein the electronic user-collaboration platform provides access to job recruiters to view the profile information (opted-in, if applicable), and provides the recruiters the ability to communicate with the researchers regarding potential employment opportunities.

15. The system of claim 14, wherein the recruiter access is provided in exchange for the payment of one or more crypto-currency tokens and/or fiat.

16. The system of claim 12, wherein the electronic user-collaboration platform awards payment of tokens to researchers based upon their activity.

17. The system of claim 16, wherein the tokens are crypto-currency tokens.

18. The system of claim 16, wherein the tokens have value within the collaboration network.

19. The system of claim 16, wherein the tokens have value outside of the collaboration network.

20. A system for collaborative development of intellectual property comprising:
a blockchain data structure storing information concerning intellectual property assets; and
an electronic user-collaboration platform having access to the blockchain data structure, (a) providing access to the intellectual property assets stored on the blockchain data structure to a plurality of researchers via an electronic network, where the blockchain data structure further includes profile information of researchers accessing the intellectual property assets on the blockchain data structure, and (b) collecting at least one credential information from the researchers as a condition to providing the researchers access to the blockchain data structure.

21. The system of claim 20, wherein the electronic user-collaboration platform further records user activity concerning user access, development, sharing and/or modification of the intellectual property assets on the blockchain data structure.

22. The system of claim 20, wherein the blockchain data structure includes profile information of researchers accessing the intellectual property assets on the blockchain data structure, and the electronic user-collaboration platform automatically updates the profile information with the credential information.

23. The system of claim 20, wherein the user-collaboration platform automatically manages the researchers' credential information on the blockchain data structure.

24. The system of claim 20, wherein the electronic user-collaboration platform automatically updates the credential information based upon the researchers' activities with respect to the intellectual property assets stored on the blockchain data structure.

25. The system of claim 20, wherein the credential information is science, technology, engineering, math, or student (STEMs) credential information.

26. The system of claim 20, wherein the credential information is one or more of: a diploma, academic transcripts, student ID, proof of employment, journal article, professional license, or letter of reference.

27. The system of claim 20, further comprising an artificial intelligence engine that determines the authenticity of the credential information.
